(19) United States
(12) Patent Application Publication
(10) Pub. No.: US 2011/0121121 A1
(43) Pub. Date: May 26, 2011

(54) FORCE LIMITER FOR A BELT RETRACTOR AND METHOD FOR MANUFACTURING SUCH A FORCE LIMITER

(75) Inventor: Klaus Frech, Korb (DE)

(73) Assignee: TRW Automotive GmbH

(21) Appl. No.: 13/017,110

(22) Filed: Jan. 31, 2011

Related U.S. Application Data
(63) Continuation of application No. 11/728,893, filed on Mar. 27, 2007.

(30) Foreign Application Priority Data
Apr. 4, 2006 (DE) 10 2006 015 655.2

(51) Int. Cl. B60R 22/28; B60R 22/34

(52) U.S. Cl. 242/379.1

(57) ABSTRACT

A force limiter (18) for a belt retractor (8) includes a torsion rod (19) which can be twisted for the purpose of force limitation, the torsion rod (19) consisting of one of an austenitic steel, for example an austenitic stainless steel which is able to be cold-formed, and a dual phase steel.

The invention further relates to a method for manufacturing such a force limiter (18).

### TECHNICAL FIELD

The invention relates to a force limiter for a belt retractor, with a torsion rod which can be twisted for the purpose of force limitation. The invention further relates to a method for manufacturing such a force limiter.

### BACKGROUND OF THE INVENTION

Belt retractors which are currently conventional for vehicle safety belts comprise a frame, a belt spool which is rotatably mounted in the frame, a torsion rod which is arranged inside the belt spool and is connected at one axial end with the belt spool so as to be locked against relative rotation, a locking disc which is connected at the other axial end of the torsion rod and has locking teeth, and a locking catch which can engage into the locking teeth of the locking disc.

The locking catch is able to be guided into the locking teeth in a belt webbing-sensitive or vehicle-sensitive manner by a known locking mechanism, such that the locking disc blocks against a rotation relative to the frame of the belt retractor. As the belt spool rests against the locking disc via the torsion rod, no belt webbing can be withdrawn from the belt spool in this state as long as the torque which is transferred from the torsion rod between the belt spool and the locking disc is not greater than the torsion resistance moment of the torsion rod. If the torsion resistance moment is exceeded and the torsion rod is twisted accordingly, a relative rotation occurs between the belt spool and the locking disc. Belt webbing is thereby withdrawn from the belt spool, which leads to a greater forward displacement of a vehicle occupant who is restrained by the safety belt. This belt webbing force limitation by means of the torsion rod serves in a known manner to reduce force peaks in the safety belt, which would otherwise greatly stress the vehicle occupant. At the same time, the withdrawal of belt webbing and hence the forward displacement of the occupant is to be limited such that it is ruled out that the occupant comes in contact with a rigid part of the vehicle (e.g. a steering wheel or an instrument panel).

In order to obtain as advantageous a belt webbing force/belt webbing withdrawal path characteristic as possible with these limiting conditions, force limiters are known from the prior art comprising torsion rods which are connected in parallel or in series. The more advantageous characteristic is achieved here by a higher expenditure in the production of the force limiter.

It is an object of the invention to improve the force limitation in belt retractors with minimal expenditure.

### BRIEF SUMMARY OF THE INVENTION

This is achieved by a force limiter for a belt retractor including a torsion rod which can be twisted for the purpose of force limitation, the torsion rod consisting of one of an austenitic steel, for example an austenitic stainless steel which is able to be cold-formed, and a dual phase steel.

Further, a method for manufacturing such a force limiter is provided.

As a result of the material deformation, the material characteristics play an essential part in a force limitation by means of a torsion rod. The restraint performance can be adapted or improved by a suitable choice of the torsion rod material with the same torsion rod design. The manufacturing expenditure remains unchanged here, apart from the material costs. A costly alteration to the design of the force limiter, for example by connecting torsion rods in parallel or in series, is not necessary.

In a preferred embodiment, the torsion rod consists of X3 CrNiCu 18-9-4 (1.4567). Through the use of this stainless steel, the diameter of the torsion rod can be reduced, with an improved pattern of the belt webbing force/belt webbing withdrawal path compared with conventional torsion rod material.

A similar improved restraint performance of the force limiter is also achieved in embodiments with a torsion rod consisting of TWIP-steel (Twinning Induced Plasticity), e.g. X5 MnAlSi 25-3-3, duplex steel, e.g. X2 CrNiMoN 22-5-3, TRIP-steel (Transformation Induced Plasticity), e.g. X1 MnAlSi 15-2-2.5 or dual phase steel, e.g. 10 MnSi 7.

In a further embodiment, the steel is thermally treated in a manufacturing process of the force limiter, the steel having preferably temperatures of at least 500° C. during the thermal treatment. The thermal treatment can last for at least 30 minutes, preferably for at least 60 minutes. Especially in case of strong twisting of several revolutions of the torsion rod, the thermal treatment has an advantageous effect on material behavior and accordingly on the restraint performance of the force limiter.

### BRIEF DESCRIPTION OF THE DRAWINGS

FIG. 1 shows a view, partially in section, of a belt retractor with a force limiter according to the invention;

FIG. 2 shows a diagram with belt webbing force/belt webbing withdrawal path characteristics; and

FIGS. 3a-3c show schematically the steps of a manufacturing method according to the invention.

### DETAILED DESCRIPTION OF THE PREFERRED EMBODIMENTS

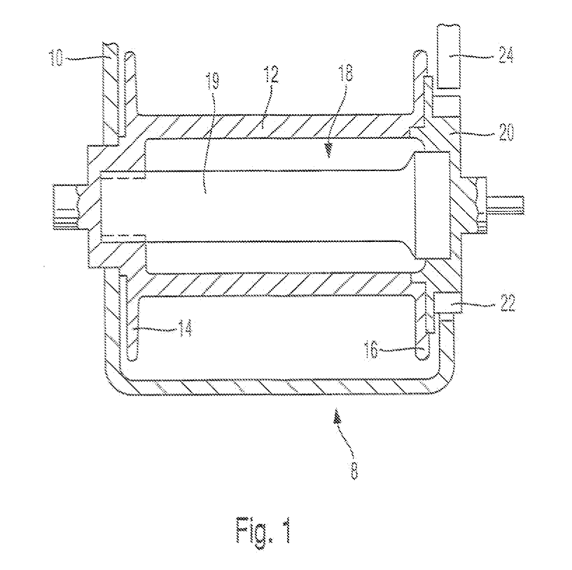

In FIG. 1 a belt retractor 8 is shown which has a frame 10 in which a belt spool 12 is rotatably mounted. The belt spool 12 has two flanges 14, 16 between which a safety belt (not shown) can be wound. A force limiter 18 is arranged inside the belt spool 12, which force limiter 18 is connected, with respect to FIG. 1, at its left axial end with the belt spool 12 so as to be locked against relative rotation, and is connected at its right axial end with a locking disc 20 (for example by splined shaft teeth). The connection between the force limiter 18 and the belt spool 12 and also with the locking disc 20 is preferably constructed with a press fit in order to guarantee a low-noise operation. The locking disc 20 is provided on its outer periphery with locking teeth 22, into which a locking catch 24 of a locking mechanism (not shown) can be guided.

In this case, the force limiter 18 is a torsion rod 19 which consists of an austenitic stainless steel which is able to be cold-formed. In particular, the stainless steel X3 CrNiCu 18-9-4 with material number 1.4567 is used for the production of the torsion rod 19.

As an alternative, the austenites X5 MnAlSi 25-3-3, X2 CrNiMoN 22-5-3, X1 MnAlSi 15-2-2.5 or the dual phase steel 10 MnSi 7 could be used.

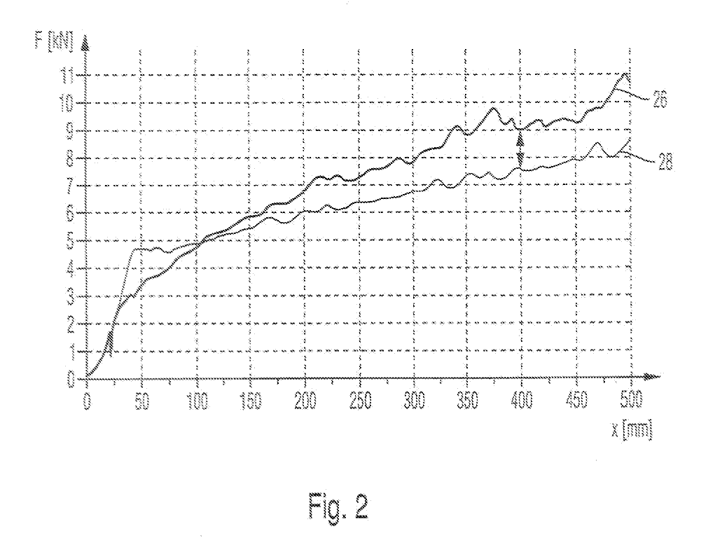

FIG. 2 shows a force/path diagram, in which a belt webbing withdrawal force F is plotted over a belt webbing withdrawal path x. The characteristic 26 drawn in a thick line is assigned here to a force limiter 18 of X3 CrNiCu 18-9-4 (1.4567) according to the invention, and the characteristic 28 drawn in a thin line is assigned to a conventional force limiter 18 of C4C according to DIN EN 10263-2 (similar to QSt 32-3) according to the prior art.

It can clearly be seen that a force limitation effect of the conventional force limiter 18, i.e. a torsion of the torsion rod 19 starts at a belt webbing force F of approximately 4.7 kN and a belt webbing withdrawal path x of just under 50 mm and then rises in a substantially linear manner. The force limitation effect of the force limiter 18 according to the invention already starts at approximately 2.7 kN and then follows a substantially curvilinear, more progressive curve, the gradient of which decreases as the belt webbing withdrawal path x increases. The advantages of this pattern of the force limiter 18 according to the invention lie in a force limitation which starts earlier and less jerkily, and in reaching higher belt webbing forces F for high belt webbing withdrawal paths x.

Clearly, this means a “gentler restraint for occupants” in “minor accidents” with low belt forces F and a belt webbing withdrawal x up to approximately 15 mm and an improved occupant restraint in “severe accidents” with high belt forces F and a belt webbing withdrawal x in the range from approximately 20 mm. A higher belt force F is necessary with the force limiter 18 according to the invention, in order to reach the same belt webbing withdrawal x (cf. double arrow in FIG. 2).

A torsion rod 19 with a diameter of 10.7 mm was used for the characteristic 26 of the force limiter 18 according to the invention, and a torsion rod 19 with a diameter of 12.0 mm was used for the characteristic 28 of a conventional force limiter 18. Therefore, in addition to an improvement in performance, a saving on material can be made, whereby the weight of the force limiter 18 is also reduced.

The level of the characteristic can be influenced here by means of the diameter of the torsion rod 19; the form or pattern of the characteristic 26 (performance) can be influenced by means of the choice of material.

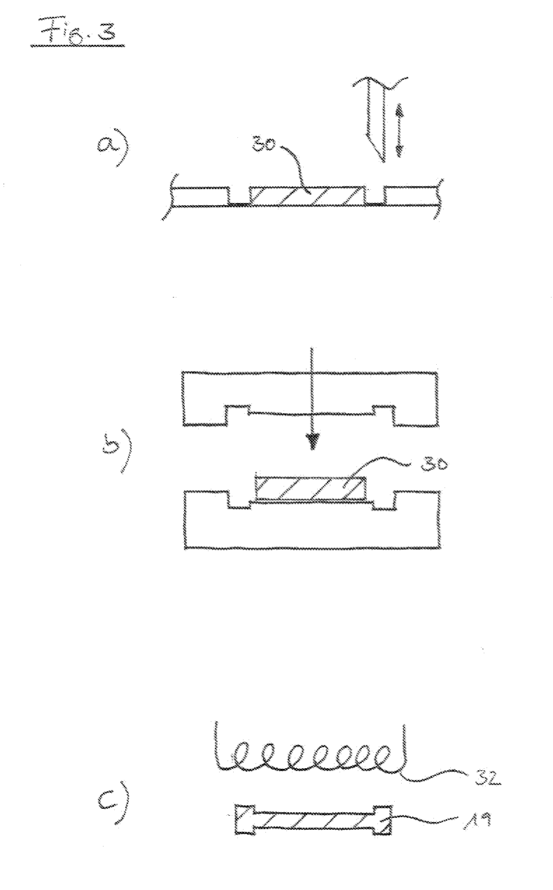

A method for manufacturing a force limiter 18 for the belt retractor 8 includes the steps schematically shown in FIGS. 3a-3c. In a first step (FIG. 3a), a steel blank 30 is provided. This steel blank 30 is transformed into a torsion rod 19 during a shaping process illustrated in FIG. 3b. Finally, a thermal treatment for the torsion rod 19 is provided by a heating device 32 (FIG. 3c).

The thermal treatment of the torsion rod 19, in particular an annealing treatment providing temperatures of minimum 500° C. for at least 30 minutes, preferably for at least 60 minutes, can have an advantageous influence on the material properties. Especially in case of a great belt webbing withdrawal x, corresponding to a strong twisting of the torsion rod 19, this has a positive effect on the form or pattern of the characteristic 26.

Preferably, the thermal treatment is conducted after the shaping process as shown in FIGS. 3a-3c. It should be clear, that it is also possible to conduct the thermal treatment by heating the steel blank 30 before the shaping process, especially when the steel employed is able to be cold-formed and the shaping process is a cold-forming process.

1-11. (canceled)

12. A belt retractor (8) comprising:
a frame (10);
a belt spool (12) rotatably mounted to the frame; and
a force limiter including a torsion rod (19) made essentially of one of an austenitic steel and a dual phase steel, the torsion rod (19) having first and second ends that rotate relative to each other when a predetermined force is applied to the torsion rod (19), the first end rotating with the belt spool (12) relative to the frame (10), the second end being prevented from rotating relative the frame (10) in response to a sensed condition.

13. The belt retractor according to claim 12, wherein the first end of the torsion rod (19) is secured to the belt spool (12) and the second end of the torsion rod (19) is secured to a locking disc (20) of the belt retractor (8).

14. The belt retractor according to claim 12, wherein the first end of the torsion rod (19) twists multiple revolutions relative to the second end when a predetermined force is applied to the torsion rod (19).

15. The belt retractor according to claim 12, wherein the torsion rod (19) consists essentially of TWIP-steel.

16. The belt retractor according to claim 12, wherein the torsion rod (19) consists essentially of duplex steel.

17. The belt retractor according to claim 12, wherein the torsion rod (19) consists essentially of TRIP-steel.

18. The belt retractor according to claim 12, wherein the torsion rod (19) consists essentially of an austenitic stainless steel.

19. The belt retractor according to claim 12, wherein the torsion rod (19) consists of a steel which is able to be cold-formed.

20. The belt retractor according to claim 12, wherein the torsion rod (19) consists of X3 CrNiCu 18-9-4 (1.4567).
